(19) United States
(12) Patent Application Publication
(10) Pub. No.: US 2015/0243169 A1
(43) Pub. Date: Aug. 27, 2015

(54) TRAFFIC LANE SITUATION DETERMINING DEVICE AND METHOD FOR DETERMINING TRAFFIC LANE SITUATION

(71) Applicant: MegaChips Corporation, Osaka-shi (JP)

(72) Inventor: Yujiro Tani, Suita-shi (JP)

(73) Assignee: MegaChips Corporation, Osaka-shi (JP)

(21) Appl. No.: 14/422,416

(22) PCT Filed: Jul. 30, 2013
(86) PCT No.: PCT/JP2013/070605

§ 371 Date: Feb. 19, 2015

(30) Foreign Application Priority Data
Aug. 22, 2012 (JP) 2012-183186

(51) Int. Cl. G08G 1/16

(52) U.S. Cl. CPC G08G 1/165; G08G 1/166; G08G 1/167

(57) ABSTRACT

A technique of determining the situation of a traffic lane. A traffic lane situation determining device includes a camera that is mounted in a vehicle and obtains an image whose object is a road in a travelling direction of the vehicle, a straight line detecting section that extracts a plurality of lines defining a traffic lane of the road from the image to detect a plurality of straight lines that respectively approximate the plurality of lines, an intersection identifying section that identifies an intersection of extended lines respectively obtained by extending the plurality of straight lines, and a traffic lane situation determining section that compares a location of the intersection with a location of a point at infinity preset in the image to determine a situation of the traffic lane.

### TECHNICAL FIELD

The present invention relates to a technique of determining the situation of a traffic lane.

### BACKGROUND ART

A conventional technique recognizes the situation of a traffic lane on the basis of an image obtained from a camera that captures an image of a road.

For example, Patent Document 1 describes the technique of grasping a traffic lane situation using an overhead image obtained by subjecting an image of a road to bird's eye view transformation (overhead transformation) to judge the travel situation of the own vehicle.

### PRIOR ART DOCUMENT

### Patent Document

Patent Document 1: Japanese Patent Application Laid-Open No. 2009-122825

### SUMMARY OF INVENTION

### Problem to be Solved by the Invention

Unfortunately, it is costly to achieve the configuration of subjecting images to bird's eye view transformation to obtain an overhead image in hardware.

The present invention therefore has an object to provide a technique of recognizing the situation of a traffic lane on the basis of an image obtained from a camera that captures an image of a road, without performing bird's eye view transformation.

### Means to Solve the Problem

A first aspect of a traffic lane situation determining device according to the present invention includes a camera that is mounted in a vehicle and obtains an image whose object is a road in a travelling direction of the vehicle, a detection section that extracts a plurality of lines defining a traffic lane of the road from the image to detect a plurality of straight lines that respectively approximate the plurality of lines, an identification section that identifies an intersection of extended lines respectively obtained by extending the plurality of straight lines, and a determination section that compares a location of the intersection with a location of a point at infinity preset in the image to determine a situation of the traffic lane.

In a second aspect of the traffic lane situation determining device according to the present invention, in the first aspect, the determination section determines that the traffic lane in the travelling direction of the vehicle is a curved line in a case where the location of the intersection is deviated horizontally with respect to the point at infinity on the image.

In a third aspect of the traffic lane situation determining device according to the present invention, in the first or second aspect, the determination section determines that the traffic lane in the travelling direction of the vehicle is a sloped traffic lane in a case where the location of the intersection is deviated vertically with respect to the point at infinity on the image.

In a fourth aspect of the traffic lane situation determining device according to the present invention, in any one of the first to third aspects, the detection section includes an extraction section that extracts a road surface area of the image, and the detection section extracts a plurality of lines defining the traffic lane of the road from an area relatively close to the point at infinity in the surface area of the image to detect a plurality of straight lines that respectively approximate the plurality of lines.

A method for determining a traffic lane situation according to the present invention includes the steps of a) extracting, from an image whose object is a road in a travelling direction of a vehicle, a plurality of lines defining a traffic lane of the road to detect a plurality of straight lines that respectively approximate the plurality of lines; b) identifying an intersection of extended lines respectively obtained by extending the plurality of straight lines, and c) comparing a location of the intersection with a location of a point at infinity preset in the image to determine a situation of the traffic lane.

### Effects of the Invention

The present invention enables the recognition of the situation of a traffic lane on the basis of an image obtained from a camera that captures an image of a road at low cost without performing bird's eye view transformation.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a block diagram showing the configuration of a traffic lane situation determining device according to a first embodiment.

FIG. 2 is a flowchart before the traffic lane situation determining device is actually operated.

FIG. 3 shows a point at infinity set on an image.

FIG. 4 is a flowchart of the actual operation of the traffic lane situation determining device.

FIG. 5 shows the state in which the situations of various traffic lanes are detected.

FIG. 6 shows the state in which the situations of various traffic lanes are detected.

FIG. 7 shows the state in which the situations of various traffic lanes are detected.

FIG. 8 shows the state in which the situations of various traffic lanes are detected.

FIG. 9 shows an example manner in which a road surface area is divided.

FIG. 10 shows how the situation of a traffic lane is detected from part of a road surface area.

### DESCRIPTION OF EMBODIMENTS

Hereinafter, embodiments will be described with reference to the drawings. The identical reference numerals throughout the drawings indicate identical or equivalent elements.

### 1. First Embodiment

[1-1. Configuration]

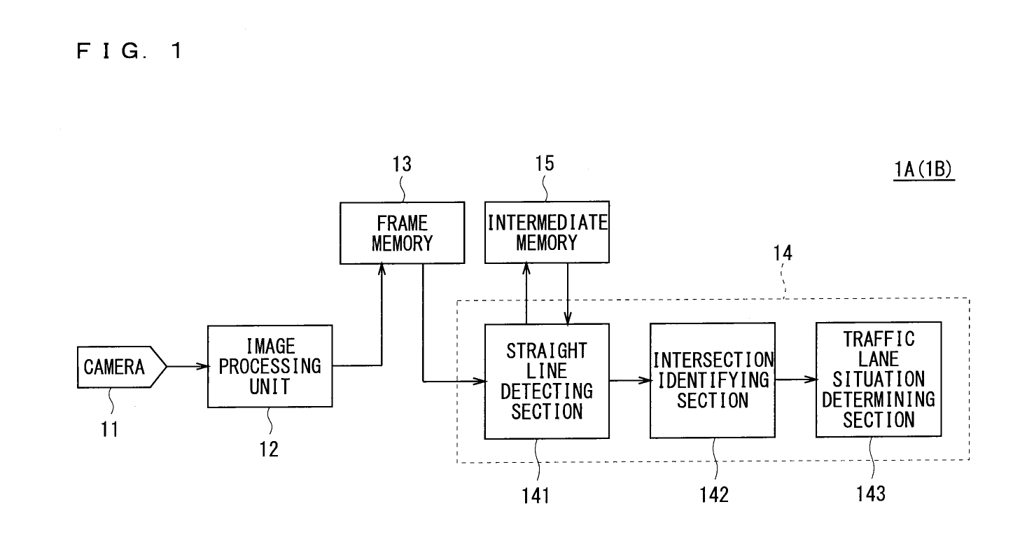

FIG. 1 is a block diagram showing the configuration of a traffic lane situation determining device 1A according to a first embodiment.

As shown in FIG. 1, the traffic lane situation determining device 1A includes a camera 11, an image processing unit 12, a frame memory 13, an information processing unit 14, and an intermediate memory 15.

The camera 11, which is mounted in a vehicle, can capture an image of a road around the vehicle. In this embodiment, the camera 11 is provided in a front portion of the vehicle (for example, a room mirror such as an inner rearview mirror) and obtains an image whose object is a road in the travelling direction of the vehicle.

The image processing unit 12 performs various types of image processing on image data of the image obtained by the camera 11. Examples of the image processing performed by the image processing unit 12 include pixel interpolation processing of determining an insufficient color component through interpolation and color space transform processing of transforming the color space of image data.

The frame memory 13 is a memory for transiently storing the image data after the image processing, which is output from the image processing unit 12.

The information processing unit 14, which is mainly composed of a CPU, a RAM, and a ROM, reads a program stored in the ROM and then execute the program by the CPU, thereby causing a straight line detecting section 141, an intersection identifying section 142, and a traffic lane situation determining section 143 to function. The functions implemented in the information processing unit 14 may be implemented by a hardware circuit.

The straight line detecting section 141 reads image data from the frame memory 13 and extracts a road surface area of an image. For example, the road surface area can be extracted by preliminarily holding a general pixel value indicating a road surface as a reference pixel value related to the road surface and comparing a pixel value of each pixel of an image with the reference pixel value. Further, the straight line detecting section 141 performs edge detection processing on the extracted road surface area and then performs straight line detection processing on the detected edge. The edge detection processing detects a plurality of lines (such as white lines) defining the traffic lane of a road, and the straight line detection processing approximately detects a plurality of straight lines extending along the plurality of lines. Each processing in the straight line detecting section 141 is performed while data during the processing is being stored in the intermediate memory 15. For example, Hough transform may be used as the straight line detection processing, which may be other processing.

The intersection identifying section 142 identifies an intersection of two extended lines on an image, which are obtained by individually extending a plurality of straight lines.

The traffic lane situation determining section 143 compares the intersection identified by the intersection identifying section 142 with the location of a point at infinity preliminarily set in an image, thereby determining the situation of a traffic lane.

[1-2. Operation]

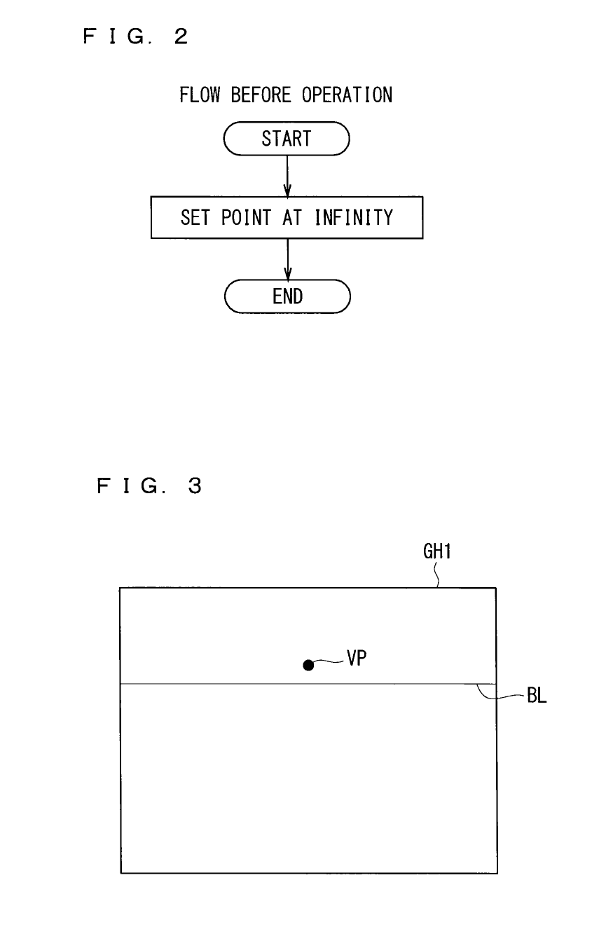

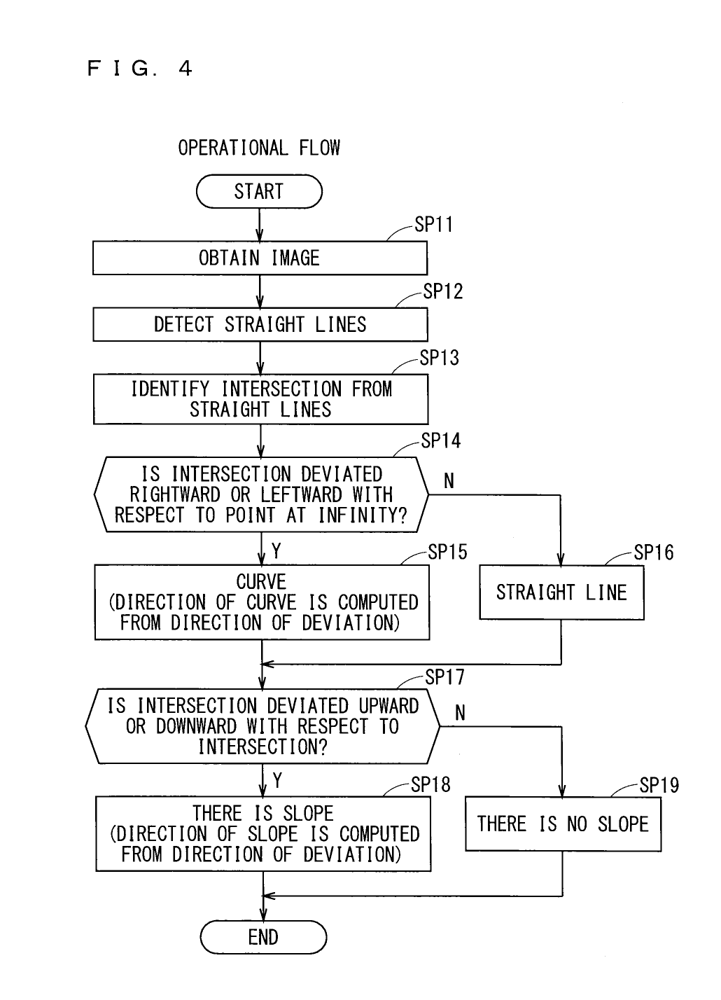

The operation of the traffic lane situation determining device 1A will now be described. FIG. 2 is a flowchart before the traffic lane situation determining device 1A is actually operated. FIG. 4 is a flowchart while the traffic lane situation determining device 1A is operated. FIG. 3 shows the point at infinity set on an image. FIGS. 5 to 8 show the state in which the situations of various traffic lanes are detected.

Before the device is actually operated, as shown in FIG. 2, a point at infinity is set on an image obtained by the camera 11. The point at infinity is a point at which straight lines parallel in the real world intersect each other on a captured image, which is also referred to as a “vanishing point.” FIG. 3 shows a point at infinity VP set on an image GH1 obtained by the camera 11. A horizontal line BL in the image GH1 indicates the location of the horizon that will appear in the image GH1 when the vehicle equipped with the camera 11 that captures the image GH1 is located in a flat place.

While the device is actually operated, as shown in FIG. 4, in Step SP11, the camera 11 first captures an image whose object is a road in the travelling direction of the vehicle. The image processing unit 12 performs predetermined image processing on the obtained image.

In Step SP12, then, the straight line detecting section 141 detects a plurality of straight lines that respectively approximate a plurality of lines defining the traffic lane of a road. FIG. 5 shows the state in which a plurality of straight lines SL1 and SL2 that respectively approximate a plurality of lines defining the traffic lane of a road are detected.

In Step SP13, the intersection identifying section 142 identifies an intersection of extended lines respectively obtained by extending the plurality of straight lines.

In Steps SP14 to SP19, then, the traffic lane situation determining section 143 compares the intersection of the extended lines with the location of the point at infinity, determining the situation of a forward traffic lane depending on the location of the intersection with respect to the point at infinity on an image.

Specifically, it is judged in Step SP14 whether the intersection is deviated rightward or leftward with respect to the point at infinity (is deviated horizontally). Whether the intersection is deviated rightward or leftward with respect to the point at infinity is judged on the basis of, for example, whether an amount of deviation exceeds a threshold (first right-to-left threshold).

If it is judged that the intersection is deviated rightward or leftward with respect to the point at infinity, the operation process moves to Step SP15, and it is determined in Step SP15 that the traffic lane in the travelling direction of the vehicle is a curved line (a curve). The direction of the curve can be identified from the direction of deviation of the intersection with respect to the point at infinity.

Meanwhile, if it is judged that the intersection is not deviated rightward or leftward with respect to the point at infinity, the operation process moves to Step SP16. It is determined in Step SP16 that the traffic lane in the travelling direction of the vehicle is a straight line.

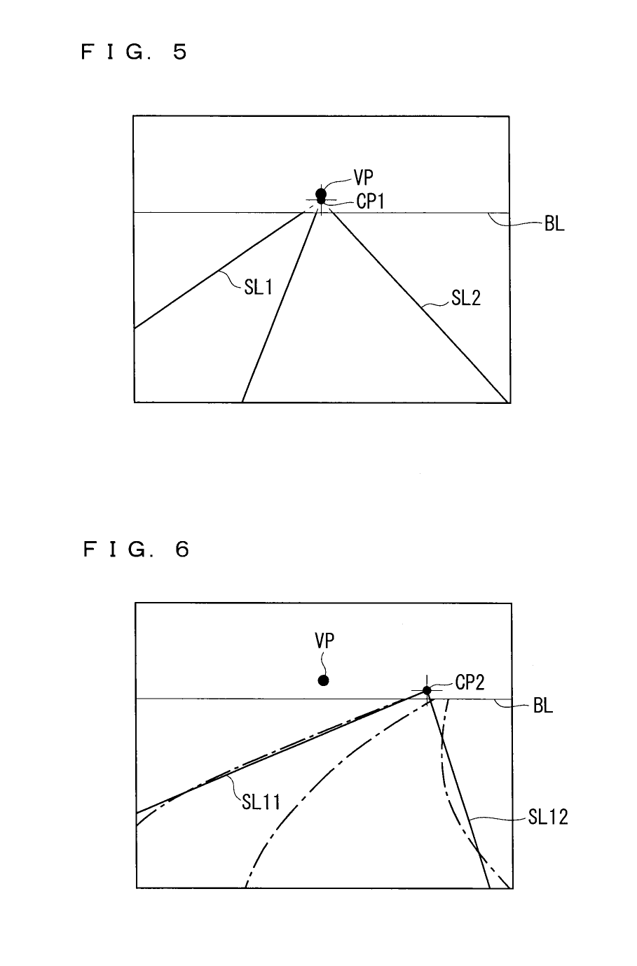

For example, FIG. 6 shows the state in which an intersection CP2 of a plurality of straight lines SL11 and SL12 is deviated rightward with respect to the point at infinity VP. If the intersection and the point at infinity VP are in the positional relationship as shown in FIG. 6, it is determined that the traffic lane in the travelling direction of the vehicle is a curved line that bends rightward.

Meanwhile, if the intersection CP1 of the plurality of straight lines SL1 and SL2 is not deviated rightward or leftward with respect to the point at infinity VP as shown in FIG. 5, it is determined that the traffic lane in the travelling direction of the vehicle is a straight line.

Then, it is judged in Step SP17 whether the intersection is deviated upward or downward with respect to the point at infinity (is deviated vertically). Whether the intersection is deviated upward or downward with respect to the point at infinity may be judged on the basis of whether an amount of deviation exceeds a threshold (second top-to-bottom threshold).

If it is judged that the intersection is deviated upward or downward with respect to the point at infinity, the operation process moves to Step SP18, and it is determined in Step SP18 that the traffic lane in the travelling direction of the vehicle is a sloped traffic lane. Whether the slope is a downslope or an upslope can be identified from the direction of deviation of the intersection with respect to the point at infinity.

Meanwhile, if it is judged that the intersection is not deviated upward or downward with respect to the point at infinity, the operation process moves to Step SP19, and it is determined in Step SP19 that the traffic lane in the travelling direction of the vehicle is a traffic lane with no slope.

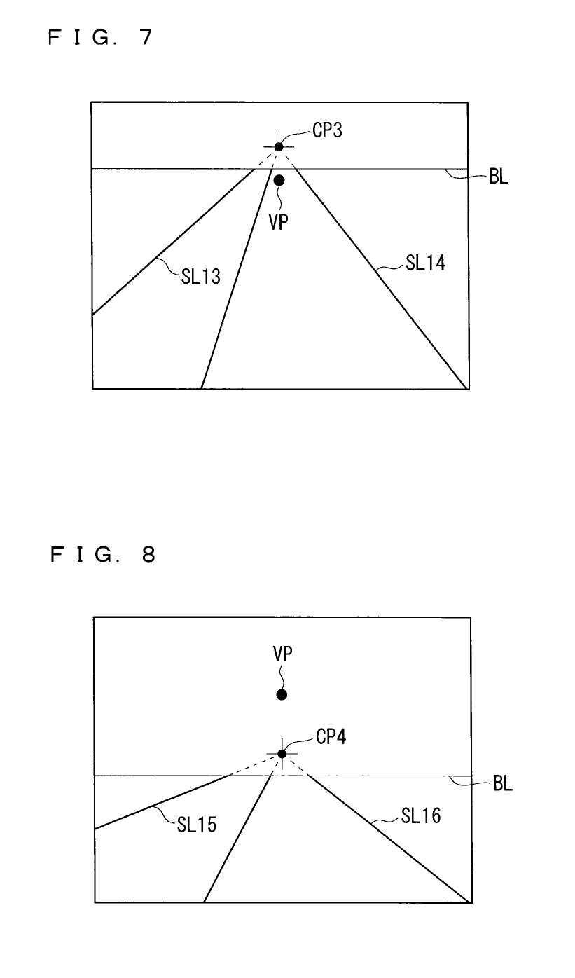

For example, FIG. 7 shows the state in which an intersection CP3 of a plurality of straight lines SL13 and SL14 is deviated upward with respect to the point at infinity VP. If the intersection CP3 and the point at infinity VP are in the positional relationship as shown in FIG. 7, it is determined that the traffic lane in the travelling direction of the vehicle is an uphill traffic lane.

Meanwhile, if an intersection CP4 of a plurality of straight lines SL15 and SL16 is deviated downward with respect to the point at infinity VP as shown in FIG. 8, it is determined that the traffic lane in the travelling direction of the vehicle is a downhill traffic lane.

As described above, the traffic lane situation determining device 1A includes the camera 11 that is mounted in a vehicle and obtains an image whose object is a road in the travelling direction of the vehicle, the straight line detecting section 141 that extracts a plurality of lines defining the traffic lane of a road from an image to detect a plurality of straight lines that respectively approximate the plurality of lines, the intersection identifying section 142 that identifies an intersection of extended lines respectively obtained by extending the plurality of straight lines, and the traffic lane situation determining section 143 that compares the intersection with the location of a point at infinity VP preliminarily set in an image to determine the situation of the traffic lane.

The traffic lane situation determining device 1A can recognize the situation of a traffic lane on the basis of an image obtained from a camera that captures an image of the road without performing bird's eye view transformation. The traffic lane situation determining device 1A, which needs no configuration for bird's eye view transformation as described above, is capable of recognizing the situation of a traffic lane at low cost.

### 2. Second Embodiment

Next, a second embodiment of the present invention will be described. Although the traffic lane situation determining device 1A according to the first embodiment detects a plurality of lines defining the traffic lane of a road using all of the road surface area in an image, a traffic lane situation determining device 1B according to the second embodiment detects a plurality of lines defining the traffic lane of a road from an area relatively close to a point at infinity in the road surface area of an image. The traffic lane situation determining device 1B is substantially similar to the traffic lane situation determining device 1A in structure and function (see FIG. 1), and thus, the common parts will be denoted by the same references and will not be described here.

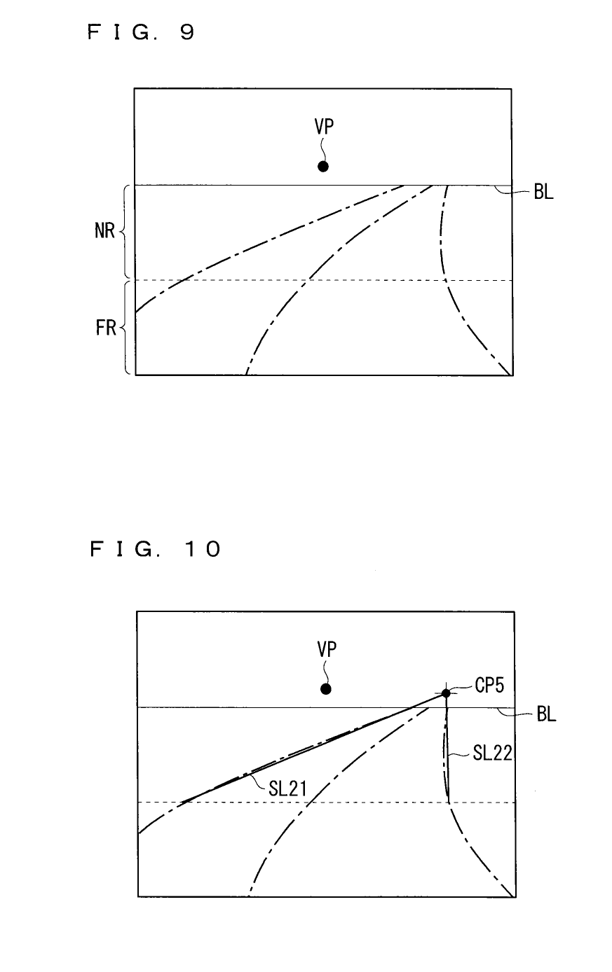

As described above, the traffic lane situation determining device 1B detects a plurality of lines defining the traffic lane of a road from part of the road surface area in an image. FIG. 9 shows an example manner in which a road surface area is divided. FIG. 10 shows a state in which the situation of a traffic lane is detected using part of the road surface area.

Specifically, the straight line detecting section 141 of the traffic lane situation determining device 1B (FIG. 1) performs edge detection processing and straight line detection processing on an area relatively close to the point at infinity in the road surface area extracted from an image. In other words, the straight line detecting section 141 extracts a plurality of lines defining the traffic lane of a road from an area relatively close to a point at infinity and then detects a plurality of straight lines that respectively approximate the plurality of lines.

More specifically, the straight line detecting section 141 divides the road surface area extracted from the image into an area NR relatively close to the point at infinity VP and an area FR relatively remote from the point at infinity VP, as shown in FIG. 9. Subsequently, as shown in FIG. 10, the straight line detecting section 141 extracts a plurality of lines defining the traffic lane of a road from the road surface area NR relatively close to the point at infinity VP and then detects a plurality of straight lines SL21 and SL22 that respectively approximate the plurality of lines.

The intersection identifying section 142 individually extends the plurality of straight lines SL21 and SL22 to identify an intersection CP5. The traffic lane situation determining section 143 compares the intersection CP5 with the location of the point at infinity VP to determine the situation of a traffic lane.

In the case where the road area in an image is divided into the area NR relatively close to the point at infinity VP and the area FR relatively remote from the point at infinity VP as shown in FIG. 9, if the traffic lane of a road in an image is a curved line, the traffic lane curves sharply in the area NR close to the point at infinity VP.

Thus, the accuracy of determining the situation of a traffic lane can be improved by, on an image, extracting a plurality of lines defining the traffic lane of a road from the road surface area NR relatively close to the point at infinity VP and detecting a plurality of straight lines SL21 and SL22 that respectively approximate the plurality of lines, as the traffic lane situation determining device 1B performs.

A road surface area is horizontally divided into two and then a plurality of lines defining the traffic lane of a road are extracted from an area close to a point at infinity VP in the description above. Alternatively, a plurality of lines defining the traffic lane of a road may be extracted from an area a predetermined distance away from the point at infinity VP in the road surface area.

While the invention has been shown and described in detail, the foregoing description is in all aspects illustrative and not restrictive. It is therefore understood that numerous modifications and variations can be devised without departing from the scope of the invention.

1. A traffic lane situation determining device, comprising:
a camera that is mounted in a vehicle and obtains an image whose object is a road in a travelling direction of said vehicle;
a detection section that extracts a plurality of lines defining a traffic lane of said road from said image to detect a plurality of straight lines that respectively approximate said plurality of lines;
an identification section that identifies an intersection of extended lines respectively obtained by extending said plurality of straight lines; and
a determination section that compares a location of said intersection with a location of a point at infinity preset in said image to determine a situation of said traffic lane.

2. The traffic lane situation determining device according to claim 1, wherein said determination section determines that the traffic lane in the travelling direction of said vehicle is a curved line in a case where the location of said intersection is deviated horizontally with respect to said point at infinity on said image.

3. The traffic lane situation determining device according to claim 1, wherein said determination section determines that the traffic lane in the travelling direction of said vehicle is a sloped traffic lane in a case where the location of said intersection is deviated vertically with respect to said point at infinity on said image.

4. The traffic lane situation determining device according to claim 1, wherein
said detection section includes an extraction section that extracts a road surface area of said image, and
said detection section extracts a plurality of lines defining the traffic lane of said road from an area relatively close to said point at infinity in said surface area of said image to detect a plurality of straight lines that respectively approximate said plurality of lines.

5. A method for determining a traffic lane situation, comprising the steps of:
a) extracting a plurality of lines defining a traffic lane of said road from an image whose object is a road in a travelling direction of a vehicle to detect a plurality of straight lines that respectively approximate said plurality of lines;
b) identifying an intersection of extended lines respectively obtained by extending said plurality of straight lines; and
c) comparing a location of said intersection with a location of a point at infinity preset in said image to determine a situation of said traffic lane.
